(19) United States
(12) Patent Application Publication
(10) Pub. No.: US 2025/0371279 A1
(43) Pub. Date: Dec. 4, 2025

(54) MULTIPHASE PROMPT OPTIMIZATION FOR LARGE LANGUAGE MODELS

(71) Applicant: Intuit Inc., Mountain View, CA (US)

(72) Inventors: Jiaxin ZHANG, Mountain View, CA (US); Xiang GAO, Mountain View, CA (US); Wendi CUI, Jersey City, NY (US); Na XU, Mountain View, CA (US); Maya Vered LIVSHITS, Mountain View, CA (US); Sourav PROSAD, Kolkata (IN); Arkadeep BANERJEE, Koikata (IN); Kun HU, Mountain View, CA (US); Andrew MATTARELLA-MICKE, Mountain View, CA (US); Vignesh Thirukazhukundram SUBRAHMANIAM, Bangalore (IN); Kamalika DAS, Saratoga, CA (US)

(73) Assignee: Intuit Inc., Mountain View, CA (US)

(21) Appl. No.: 18/679,426

(22) Filed: May 30, 2024

(51) Int. Cl. G06F 40/35

(52) U.S. Cl. CPC G06F 40/35

(57) ABSTRACT

A method further includes performing the following phases for at least two iterations. In a first phase, the method includes, iteratively, applying an evolutionary algorithm to a current instruction to generate a revised instruction, testing, by applying a large language model (LLM), prompts including the current instruction and the revised instruction, respectively, training examples selected by the example selector to obtain test results, comparing the test results to obtain a comparison result, setting the revised instruction as the current instruction, and exiting the first phase when the comparison result satisfies a first phase stop condition. In a second phase, the method further includes selecting, by the example selector, training examples, testing, using the current instruction, the training examples to obtain a test result, and modifying, after executing the first phase, the example selector based on the test result.

### BACKGROUND

Large language models (LLMs) are artificial neural network models that have millions or more parameters and are trained using self- or semi-supervised learning. For example, LLMs may be pre-trained models that are designed to recognize text, summarize the text, and generate content using very large datasets. LLMs are general models rather than specifically trained on a particular task. LLMs are not further trained to perform specific tasks. Further, LLMs are stateless models, each request is processed independently of other requests even from the same user or session.

LLMs may be used as a backend for a prompt-based application. A prompt-based application is an application built using LLMs to process a series of prompts. Prompt-based applications leverage the generative capabilities of LLMs to respond to user inputs based on predefined set of instructions and examples. When the instructions or examples are suboptimal, LLMs may generate hallucinations or incomplete responses. A challenge exists in designing effective instructions for prompt-based applications. This challenge is exacerbated as different versions and different LLMs are used.

### SUMMARY

In general, in one aspect, one or more embodiments relate to a method that includes obtaining a current instruction and an example selector. The method further includes performing the following phases for at least two iterations. In a first phase, the method includes, iteratively, applying an evolutionary algorithm to the current instruction to generate a revised instruction, testing, by applying a large language model (LLM), a first prompt including the current instruction with a first set of training examples selected by the example selector to obtain a first test result, testing, by applying the LLM, a second prompt including the revised instruction with a second set of training examples selected by the example selector to obtain a second test result, comparing the first test result to a second test result to obtain a comparison result, setting the revised instruction as the current instruction, and exiting the first phase when the comparison result satisfies a first phase stop condition. In a second phase, the method further includes selecting, by the example selector, a third set of training examples, testing, using the current instruction, the third set of training examples to obtain a third test result, and modifying, after executing the first phase, the example selector based on the third test result.

In general, in one aspect, one or more embodiments relate to computing system that includes memory storing instructions and a computer processor for executing the instructions to cause the computer system to perform operations. The operations further include performing the following phases for at least two iterations. In a first phase, the operations include, iteratively, applying an evolutionary algorithm to the current instruction to generate a revised instruction, testing, by applying a large language model (LLM), a first prompt including the current instruction with a first set of training examples selected by the example selector to obtain a first test result, testing, by applying the LLM, a second prompt including the revised instruction with a second set of training examples selected by the example selector to obtain a second test result, comparing the first test result to a second test result to obtain a comparison result, setting the revised instruction as the current instruction, and exiting the first phase when the comparison result satisfies a first phase stop condition. In a second phase, the operations further include selecting, by the example selector, a third set of training examples, testing, using the current instruction, the third set of training examples to obtain a third test result, and modifying, after executing the first phase, the example selector based on the third test result.

In general, in one aspect, one or more embodiments relate to a method that includes obtaining a current instruction and an example selector and performing the following phases for at least two iterations. In a first phase, the method includes iteratively, applying an evolutionary algorithm to the current instruction to generate a revised instruction, testing, by applying a large language model (LLM), a first prompt including the current instruction with a first set of training examples selected by the example selector to obtain a first test result, testing, by applying the LLM, a second prompt including the revised instruction with a second set of training examples selected by the example selector to obtain a second test result, comparing the first test result to a second test result to obtain a comparison result, setting the revised instruction as the current instruction, and exiting the first phase when the comparison result satisfies a first phase stop condition. The method further includes, in a second phase, selecting, by the example selector, a third set of training examples, testing, using the current instruction, the third set of training examples to obtain a third test result, and modifying, after executing the first phase, the example selector based on the third test result. The method further includes deploying the current instruction and the example selector to a production environment.

Other aspects of the invention will be apparent from the following description and the appended claims.

### BRIEF DESCRIPTION OF DRAWINGS

FIG. 1 shows a diagram of a production system in accordance with one or more embodiments.

FIG. 2 shows a diagram of a training system in accordance with one or more embodiments.

FIG. 3 shows a flowchart for training the LLM prompt creator in accordance with one or more embodiments.

FIG. 4 shows a flowchart for prompt engineering in an evolutionary algorithm framework, in accordance with one or more embodiments.

FIG. 5 shows a flowchart for determining distinct parent prompts for crossover mutation in an evolutionary algorithm framework, in accordance with one or more embodiments.

FIG. 6A, FIG. 6B, and FIG. 6C show an example in accordance with one or more embodiments.

FIG. 7A and FIG. 7B shows a computing system in accordance with one or more embodiments of the invention.

Like elements in the various figures are denoted by like reference numerals for consistency.

### DETAILED DESCRIPTION

In general, embodiments are directed to a multiphase approach for prompt optimization in accordance with one or more embodiments. A prompt is a request to a large language model (LLM) that request that the LLM provide an answer in accordance with the prompt. Namely, the LLM processes the prompt and provides an answer. Prompts are predominantly generated by humans and are prone to have inconclusive language that may cause the LLM to return sub-optimal answers. For example, the answer may be irrelevant, or mathematically or factually wrong. Moreover, prompts that are developed for one version of an LLM, for example, ChatGPT 3.0 may not be as effective or relevant when processed by a later version, for example, ChatGPT 4.0. Further, LLM behavior may be manipulated by exploiting loopholes in LLM guidelines to elicit unethical responses. Furthermore, sensitive data may be unintentionally revealed through prompts compromising data integrity and privacy. The widespread deployment of LLMs in enterprises engenders the emergent technology domain of designing effective prompts.

Generally, a prompt includes multiple segments. The multiple segments may include one or more of a user input segment, an instruction, examples (e.g., few-shot examples), and an output format. The user input segment is the input of a user. The instruction is the application generated portion of the prompt that tells the LLM how to answer the user input segment. The examples are example input output pairs of the example outputs that should be produced for given example inputs. The output format has formatting instructions for the output.

Of the segments of the prompt, the instruction and the examples can be controlled by the application or application vendor to generate an accurate and complete response. Prompt engineering entails designing effective instructions and examples that elicit specific responses from an LLM, considering factors like context, wording, and constraints. One or more embodiments perform a multiphase optimization of the instruction and the example selector. An example selector selects examples that are part of the prompt and designed to help the LLM in understanding the instruction (e.g., through examples removing any ambiguity in the instruction). In the first phase that is iteratively performed, the instruction is optimized through an evolutionary algorithm. During the first phase, the example selector that is used to select the examples is frozen (i.e., not updated). The optimization of the instruction may be performed through several iterations until a first phase stop condition is reached. The second phase includes updating the example selector to improve how the example selector selects and orders examples. During the second phase, the example selector is iteratively updated while the instruction is frozen. When the second phase completes, the first phase may be performed again. The multiphase optimization provides a unified alternating optimization approach in which the instruction and the example selector are optimized together to create a prompt that addresses the user intent.

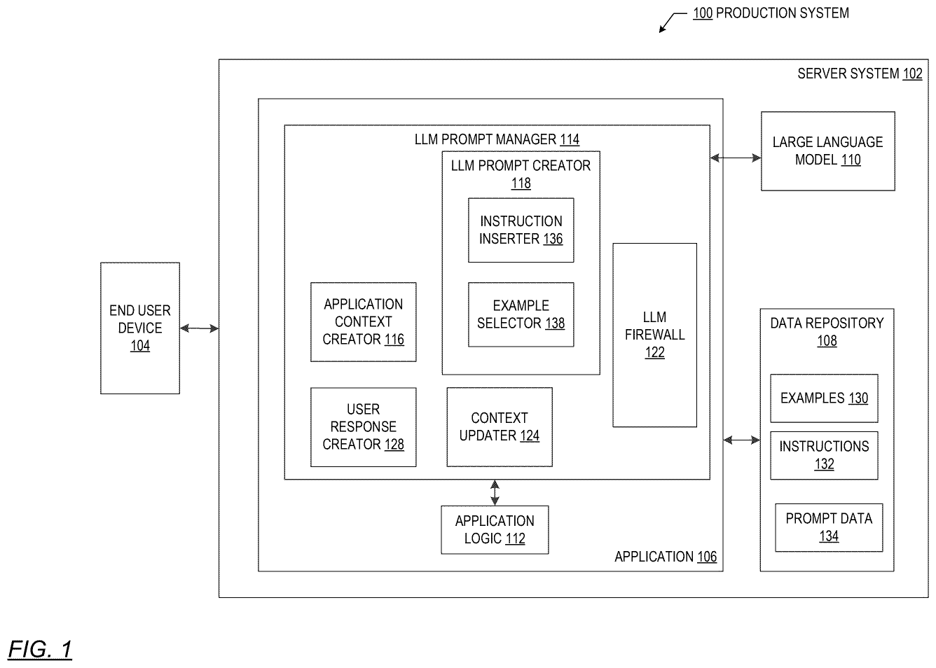

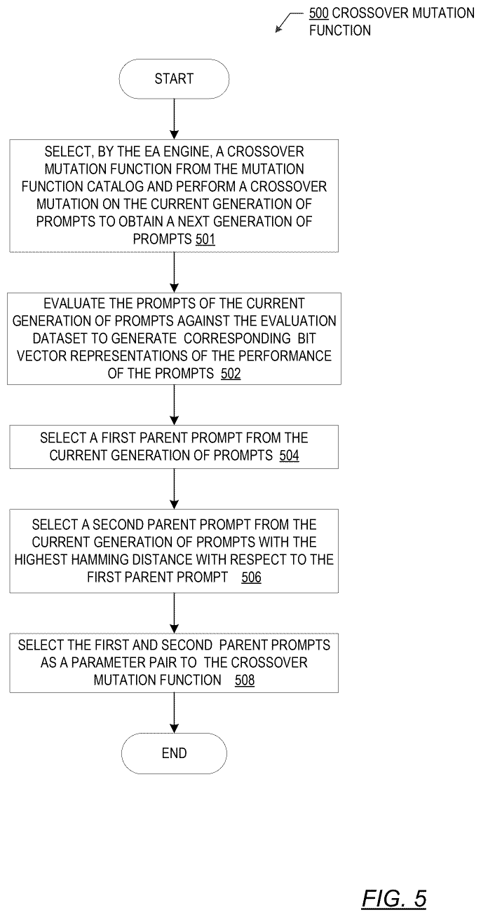

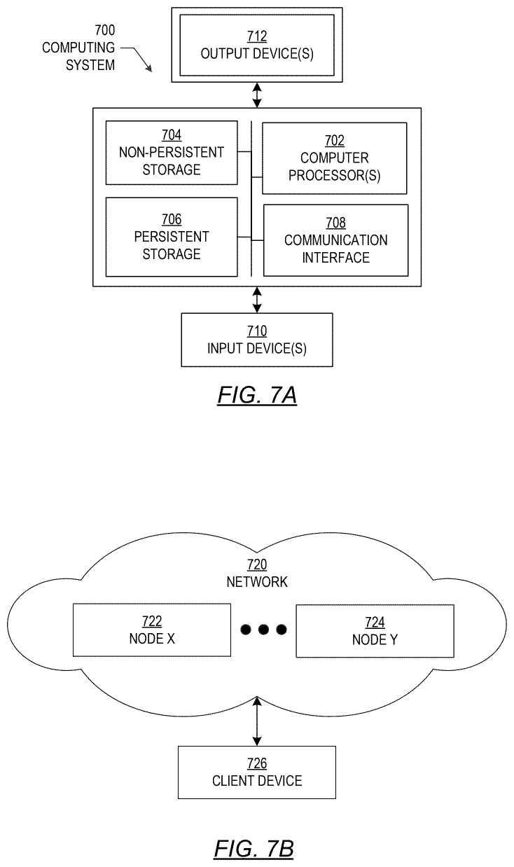

Turning to the figures, FIG. 1 shows FIG. 1 shows a diagram of a production system (100) in accordance with one or more embodiments. One or more embodiments detect prompt injection attacks based on responses from the LLM. Turning to FIG. 1, a server system (102) is shown in accordance with one or more embodiments. The server system (102) may correspond to the computing system shown in FIGS. 5A and 5B. The server system (102) is configured to interface with an end user device (104) and process LLM queries and responses. An end user device (104) is a device that may be used by an end user. For example, an end user device (104) may be the computing system shown in FIG. 7A and FIG. 7B. The end user device (104) is directly or indirectly connected to the server system (102). The end user device (104) is configured to transmit a user prompt segment to the server system (102). The term, “end user”, is the originator of a prompt segment. The term, “end user,” is the end user that originates the user prompt segment. The end user may generate the user prompt segment directly or through the aid of a computing system, such as another machine learning model. The user prompt segment is text that is part of the prompt from an end user requesting to obtain a particular response. For example, the user prompt segment may be a request asking a question, a request for information, a request for content, etc.

The user prompt segments may be combined with other prompt segments. A prompt segment is a portion of a prompt that is transmitted to the LLM. For example, the other prompt segments may include additional prompt segments from one or more prompt data sources (not shown), instructions, and examples. The additional prompt segment from another prompt data source may be additional information to populate that is added in addition to the user prompt segment. For example, the additional prompt segment may be context information, or information referenced in the user prompt segment.

The server system (102) may be controlled by a single entity or multiple entities. The server system (102) includes an LLM (110), application (106), and a data repository (108).

The data repository (108) is any type of storage unit and/or device (e.g., a file system, memory, storage, database, data structure, or any other storage mechanism) for storing data. The data repository (108) is configured to store training data (142), a response schema (144), one or more security events (146), and prompt data (148).

The data repository (108) includes functionality to store a set of examples (130), a set of instructions (132), and prompt data (134). Examples (130) may be partitioned according to types of prompts, whereby the type of prompt may be defined by the user input segment or the instruction. The examples identify the correct output for a particular type of prompt. For example, if the type of prompt requests that the LLM output a Haiku for a user input segment, the examples may be various Haikus. As another example, if the type of prompt requests that the LLM classify a portion of the prompt between two or more classes, the examples may be example input pre-classified into the different classes (e.g., tiger is feline, lynx is feline, cougar is feline, lion is feline, wolf is canine, dog is canine, dingo is canine, and jackal is canine). Examples (130) may be included in the prompt to assist the LLM to generate the correct output.

The instructions (132) are instructions added to the LLM prompt by the LLM prompt manager to assist in responding to the user input segment. For example, the instructions (132) may be instructions clarifying the user prompt segment, instructions for responding to the user prompt segment, instructions referencing context information for the user prompt segment, prohibited response instructions that limit the responses to the prompt (e.g., limit for security, limit to a particular domain, etc.).

The prompt data (134) may include a unique prompt identifier that is a unique identifier of the particular prompt. For example, the prompt identifier may be a numeric identifier or sequence of characters that uniquely identify a prompt. The prompt identifier may be a concatenation of multiple identifiers. For example, the prompt identifier may include a user identifier, a session identifier, and an identifier of the prompt itself. The same prompt identifier may be used for the user prompt as the for the LLM prompt. The prompt data (134) may further include the prior prompts, context information, information about the user, etc.

The LLM (110) complies with the standard definition used in the art. Specifically, the LLM (110) has millions or more parameters, is generally trained on large quantities of unlabeled text using self-supervised learning or semi-supervised learning. The LLM (110) can understand natural language and generate text and possibly other forms of content. Examples of LLMs include GPT-3® model and GPT-4® model from OpenAIR company, LLaMA from Meta, and PaLM2 from Google®.

The application (106) is a software application that is configured to interact directly or indirectly with an end user. For example, the application (106) may be a web application, a local application on the end user device (104), or another application. The application (106) may be dedicated to being an intermediary between the end user device (104) and the LLM (110) or may be a standalone application that uses the features of the LLM to perform specific functionality for the end user. For example, the application (106) may be all or a portion of a program providing specific functionality, a web service, or another type of program. By way of an example, the application (106) may be a chat program or help program to provide the end user with assistance in performing a task. As another example, the application (106) may be a dedicated application, such as a word processing application, spreadsheet application, presentation application, financial application, healthcare application, or any other software application that may use the LLM (110) to respond to the end user. The application (106) includes application logic (112) connected to an LLM prompt manager (114). The application logic (112) is a set of instructions of the application (106) that provides the functionality of the application (106).

The LLM prompt manager (114) is a software component that is configured to act as an intermediary between the end user device (104) and the LLM (110). Specifically, the LLM prompt manager (114) is configured to obtain a user prompt segment from the end user via a user interface (not shown), add zero or more additional prompt segments to the user prompt segment to generate an LLM prompt, interface with the LLM (110), and provide a user response to the end user based on the user prompt segment. The user prompt segment is any prompt that is received by the LLM prompt manager (114), directly or indirectly, from the end user device (104) for processing regardless of whether the user prompt segment is an initial or subsequent prompt received. For example, the user prompt segment may be an initial prompt transmitted by the end user device to the LLM prompt manager, or a subsequent prompt received in subsequent interactions of a series of interactions with the end user device (104). The user response is the response that is directly or indirectly transmitted to the end user device (104).

The LLM prompt manager (114) includes an application context creator (116), an LLM prompt creator (118), an LLM firewall (122), a context updater (124), and a user response creator (128). The application context creator (116) is configured to gather application context for the LLM prompt. The application context may include information about an end user's session with the application logic (112) such as operations that the end user is attempting to perform with the application, length of time that the end user is using the application, type of application, functionality provided by the application, a current window being displayed to the end user, etc. The application context may further include administrative information about the end user (e.g., age of end user, type of end user, etc.). The application context may further include historical prompt information. The historical prompt information may include previous LLM prompts for the end user and responses to the previous LLM prompts for the end user.

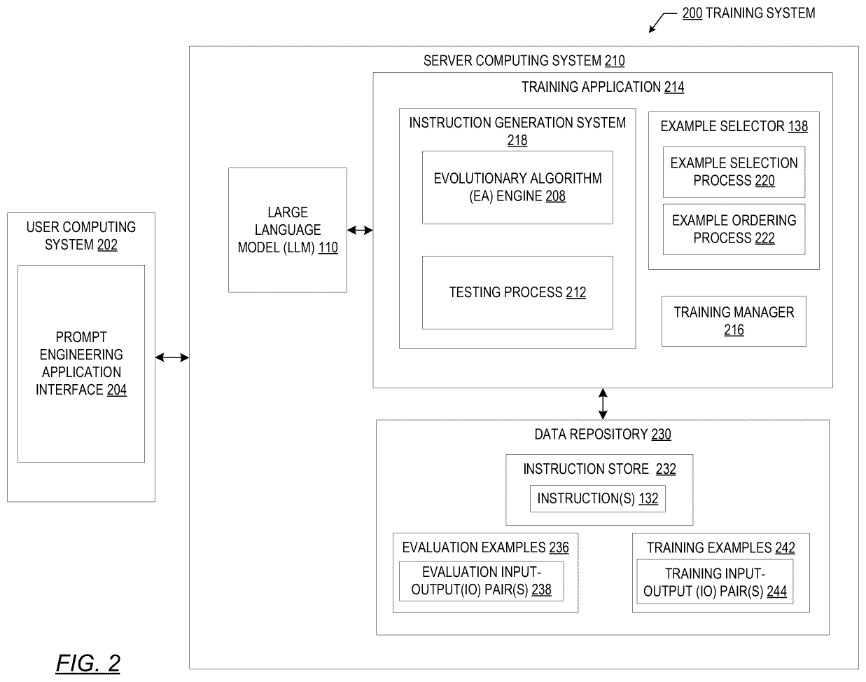

The LLM prompt creator (118) is configured to generate an LLM prompt from application context, the end user prompt segment, third party information, instructions, and examples. The LLM prompt creator (118) includes an instruction inserter (136) and an example selector (138). The instruction inserter (136) is configured to select and insert instructions (132) into the prompt. For example, the instruction inserted may select the instructions based on matching with the user prompt segment, a classification of the user prompt segment, or using another technique. The example selector (138) is configured to select examples (130) and insert the selected examples into the prompt. The example selector (138) may further be configured to order the selected examples when inserting the examples into the prompt. Training the example selector (138) and generating the instructions (132) may be performed using the training system shown in FIG. 2.

Continuing with FIG. 1, an LLM firewall (122) is a firewall for the LLM prompt manager (114) that monitors traffic with the LLM (110). For example, the LLM firewall (122) may be designed to prevent prohibited prompts from being transmitted to the LLM (110) or prohibited responses from being transmitted to the end user.

The context updater (124) is configured to update the application context based on the LLM response. For example, the context updater (124) may be configured to add the LLM response to the application context.

The user response creator (128) is configured to create a user response from the LLM response. The user response may be the LLM response with the context information removed, a modification of the LLM response, or another response that is based on the LLM response.

FIG. 2 shows a diagram of a training system (200) in accordance with one or more embodiments. The training system (200) is configured to train the example selector (138) and the instructions (132) in accordance with one or more embodiments. The training system (200) includes a server computing system (210) communicatively coupled to a user computing system (202). The server computing system (210) and user computing system (202) may be computing systems such as described below with reference to FIG. 7A and FIG. 7B. The server computing system (210) may be the same or different than the server computing system (210) described in FIG. 1. Both of the computing systems are described below.

The user computing system (202) is a computer system that is configured to execute a prompt engineering application interface (204). The prompt engineering application interface (204) includes computer program code that is configured to interact with the server computing system (210). For example, the prompt engineering application interface may be a web browser or an interface of another application. In one embodiment, the prompt engineering application interface (204) is configured to interact with the LLM (110) via the server computing system (210). In one embodiment, the prompt engineering application interface (204) presents the user with graphical artifacts that are configured to present an interactive graphical user interface to the user for interacting with the LLM (110) via the server computing system (210). For example, the prompt engineering application interface (204) may be an AI copilot executing in a web-browser. Examples of AI copilots include the Bing copilot on Microsoft Edge®, Intuit Assist®, Shopify Sidekick®, and the like. A user may engage in a conversation with the LLM via the prompt engineering application interface.

The server computing system (210) includes an LLM (110) and a data repository (230). The LLM (110) may be the same or similar to the LLM (110) described above with reference to FIG. 1. The data repository (230) is a type of physical storage unit or physical storage device (e.g., a file system, database, data structure, or any other storage mechanism) for storing data. The data repository (230) may include multiple different, potentially heterogeneous, storage units and/or devices. The data repository (230) is operatively and communicatively to the training application (214).

The data repository (230) includes an instruction store (232). The instruction store (232) is a logical data structure that stores multiple instructions (132). In one or more embodiments, the instruction store (232) may store instructions in various types of data structures, for example, vector stores, database records, data frames, lists, arrays, tables, and the like. In one or more embodiments, the instructions (132) may be stored as an ordered set, for batch processing by the LLM. In other embodiments, the instructions (132) may be stored in one or more groups, a group representing a generation of candidate instructions for prompt engineering and optimization by the training application (214). Prompts with the instructions (132) may be presented to an LLM via the prompt engineering application interface. Additionally, prompts may be provided programmatically to an LLM via application programming interface (API) calls, for example, OpenAI API.

The data repository (230) includes training examples (242) and evaluation examples (236). The training examples (242) include one or more training input-output (IO) pairs (244). The evaluation examples (236) includes one or more evaluation input-output (IO) pairs (238). A training IO pair is an IO pair (described below) used for training the LLM to generate a specific prompt. An evaluation IO pair is an IO pair (described below) used to evaluate the effectiveness of the LLM-generated prompt.

An input-output (IO) pair is a pair of input and output. The output is the desired output of the LLM for the particular prompt. Each IO pair has an input with a corresponding output. The input is an example of a user prompt segment. The corresponding output is a response that the LLM should generate when provided with the input. In one embodiment, a user prompt segment of an IO pair is a parameter previously presented with a prompt to an LLM. The corresponding output of the IO pair is the response generated by the LLM processing the user prompt segment in accordance with the previously presented prompt. The input and output pair have at least one relationship that is comprehensible by the LLM. In one or more embodiments, the examples are pre-validated. For example, the corresponding output may be identified by a reviewer as being correct (e.g., accurate and complete) for the given input of the example. Examples may be partitioned into sets based on the type of prompt.

By way of some examples, the input may include the sentence: “Name the top three highest mountain ranges on the planet.” The corresponding output of the IO pair may include the sentence: “The Himalayas, Andes and the Rockies.”

In another example, the user prompt segment of an IO pair may include the sentences: “The man turned down the volume of the radio.” and “The man could not hear the woman what the woman was saying.” The corresponding output of the IO pair may include the sentences: “Cause: The man could not hear the woman speak,” and “Effect: The man turned down the volume of the radio.”

In one or more embodiments, the input of an IO pair may include parameters previously presented with a previous prompt to the LLM, and an incorrect response generated by the LLM. The corresponding output of the IO pair may include a correct response. For example, the user prompt segment may include the sentences: “Parameters: The man turned the volume down; The man could not hear what the woman was saying, Incorrect response: Cause - - - The man turned the volume down; Effect - - - The man could not hear what the woman was saying.” The corresponding output of the IO pair may include the sentences “Correct response: Cause - - - The man could not hear what the woman was saying; Effect - - - The man turned the volume down.” In the example, the output of the IO pair may be provided or validated by a user via the prompt engineering application interface.

IO pairs may be created via one or more conversations or interactions with the LLM wherein the parameters and corresponding responses are stored in the data repository as IO pairs in the training examples or in the evaluation examples. Thus, an IO pair in the training examples may be referred to as a “training IO pair” or a “training example.” The input and output of a training IO pair are referred to as “training input” and “training output” respectively. Likewise, an IO pair in the evaluation dataset may be referred to as an “evaluation IO pair” or an “evaluation example.” The input and output of an evaluation IO pair are referred to as “evaluation input” and “evaluation output” respectively.

The server computing system (210) includes a training application (214). The training application (214) is communicatively and operatively coupled to the LLM (110) and the data repository (230). The training application (214) is an application executing on the server computing system (210) that is configured to orchestrate and automate the optimization of a prompt in accordance with the structure and flow of an evolutionary algorithm and machine the selection of examples.

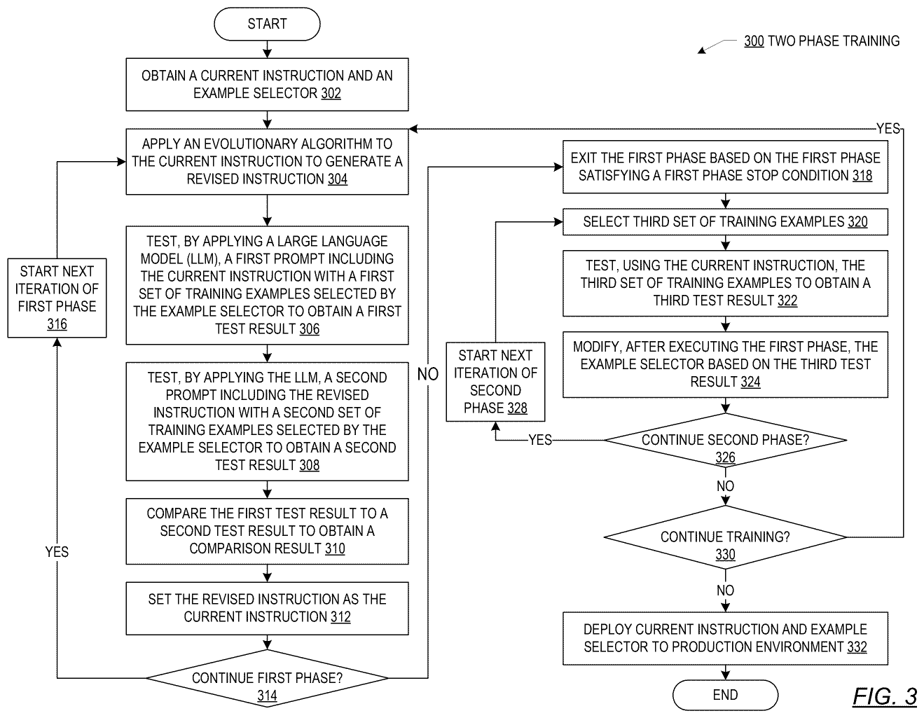

The training application (214) includes a training manager (216). The training manager (216) is configured to iterate between two phases of prompt optimization. Specifically, the training manager (216) is configured to trigger the instruction generation system (218) to update one or more instructions (132). The training manager (216) is further configured to update the example selector (138). The processing described by the various components of the training application (214) is described in FIG. 3.

The training manager (216) is connected to the instruction generation system (218). The instruction generation system (218) includes an evolutionary algorithm (EA) engine (208). Processes in the EA engine (208) include initialization, selection, mutation, and recombination. Initialization in the EA engine (208) entails the creation of an initial population of existing candidate solutions. Selection in the EA engine (208) entails the selection of a current generation of candidate solutions with a higher fitness for undergoing mutation. Mutation in the EA engine (208) entails the introduction of changes to candidate solutions of the current generation, resulting in a next generation of candidate solutions. Recombination in the EA engine (208) entails the partial combination of two or more generations of candidate solutions.

The testing process (212) is configured to test the instructions in a prompt and stop execution when the result satisfies a phase stop condition for the instruction update. For example, the testing process (212) may trigger the EA engine (208) to iteratively operate until the stop condition is satisfied. The phase stop condition may be a threshold difference or a number of iterations. For example, the phase stop condition may be that the difference between the next generation and the current generation of candidate solutions is lower than a threshold difference. The threshold difference fixes a state of convergence between successive generations of candidate solutions and serves as a boundary condition to halt iteration of the sequence of processes. The threshold difference may be a configuration variable of the testing process.

The EA engine (208) further includes a selection function catalog, a mutation function catalog, and a fitness function catalog. As a general overview, a function catalog is an inventory of software functions, organized to optimize access, usage, and maintainability. Accordingly, the selection function catalog is an inventory of selection functions. A selection function selects a set of instructions to undergo mutation. Selection functions favor instructions with higher fitness scores, while gradually eliminating instructions with lower fitness scores, determining the instructions that contribute to the next generation, and the instructions that are discarded. Examples of selection functions in the selection function catalog include Roulette Wheel selection, Boltzmann selection, Elitism selection, Stochastic Universal Sampling, and the like.

The mutation function catalog is an inventory of mutation functions. A mutation function effects optimizations to the instructions while maintaining the diversity of the instruction generation undergoing mutation. Examples of mutation functions in the mutation function catalog include gradient descent mutation, cross over mutation, group mutation, semantic mutation, and the like. In one embodiment, a mutation function may be performed by an LLM agent that processes an existing instruction presented as an input to generate a new instruction as a response. The new instruction is mutated from the instruction presented as the input. The new instruction retains some features from the input instruction includes a changed or new feature introduced by the mutation.

The fitness function catalog is an inventory of fitness functions. A fitness function, in the context of the EA framework, evaluates the quality of the next generation of instructions generated in the mutation process. The fitness functions assign fitness scores to instructions based on how an instruction matches the desired criteria, for example, a fitness score threshold. The fitness functions serve to direct the EA framework toward an optimal path by favoring instructions with higher fitness scores. The fitness functions influence which instructions survive and undergo further mutation over multiple generations. Different fitness functions may focus on diverse aspects of the instructions, for example, maximizing instruction performance, minimizing instruction generation costs, and the like. Examples of fitness functions in the fitness function catalog include similarity scoring based on cosine similarities, F1 scoring, toxicity scoring, accuracy metric of an instruction, and the like. One example of toxicity scoring applies the Perspective Application Programming Interface (API) from Jigsaw® to obtain the toxicity score of the instruction. Perspective API is a machine learning-based API including functionality to recognize and mitigate semantic toxicity and promote healthy dialogue in online conversations. One example of an accuracy metric is to calculate the exact match of the output and the ground truth, by dividing the number of exact matches with the total number of candidate instructions. For example, a ground truth may be a “True/False” type answer, and the output can be evaluated against the ground truth for an exact match.

The example selector (138) includes an example selection process (220) and an example ordering process (222). The example selection process (220) is configured to select examples (as described in reference to FIG. 1) for inclusion in a prompt. Example selection is based on parameters including selection parameter defining a number of examples that is selected and a parameter for determining which examples to select. The example ordering process may be defined by an ordering parameter. Each of the parameters are configurable through training. The example selection process (220) may be configured to apply multiple sample selection strategies and apply weights to the outputs of the different strategies. For example, the example selection strategies may include K-nearest neighbor, random selection or clustering selection strategy. The training of the example selection process (220) may include balancing the weights between the different example selection strategies.

The example ordering process (222) is directed to ordering the examples when included in the prompt. For example, the example ordering process may be performed with an entropy-based method according to an ordering parameter.

FIG. 3 shows a flowchart for training the LLM prompt creator in accordance with one or more embodiments. In Block 302, a current instruction and an example selector are obtained. The initial example selector may be a random example selector or an example selector that is based on a predefined set of parameters.

To generate the instruction, the training examples may be used. An initial set of training examples may be randomly selected. Each example in the initial set of training examples including an input and a corresponding output. From the initial set of training examples, a request to the LLM may be generated. The request requests that the LLM define an instruction that produces the corresponding output from the input for each example in the initial set of examples. Namely, the LLM evaluates the initial set of examples to identify the common relationship amongst the examples between the input and the corresponding output. The LLM then uses the common relationship to generate an instruction that, if provided to the LLM with the input, would result in the LLM generating the corresponding output for the particular input. The instruction is received from the LLM and may be used as the current instruction. The processing may be performed multiple times to generate multiple initial current instructions. The multiple different current instructions may be used as described below in the evolutionary algorithm.

Then, for multiple iterations, one or more embodiments proceed to perform at least two phases. In the first phase, which is iteratively performed, the instruction is updated.

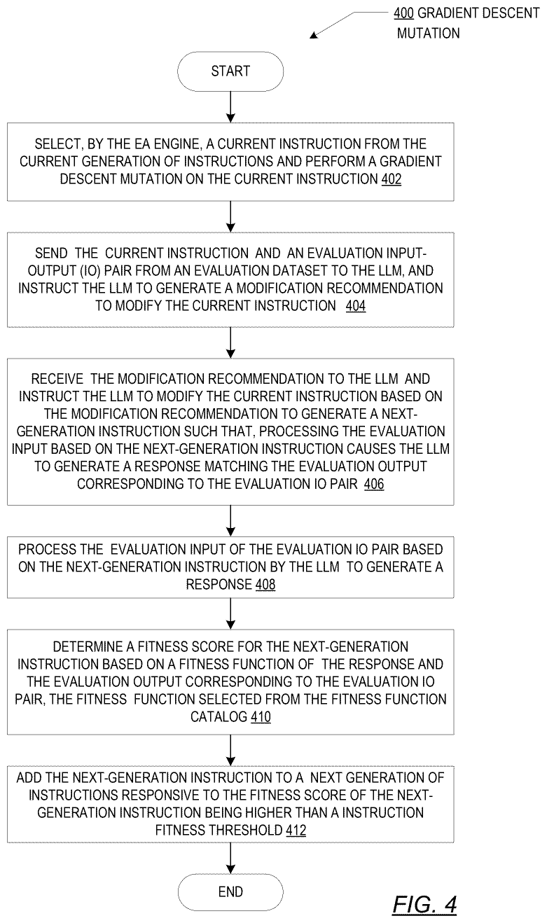

In Block 304, an evolutionary algorithm is applied to the current instruction to generate a revised instruction. Applying the evolutionary algorithm may include mutating the current instruction to generate the revised instruction. Applying the evolutionary algorithm may include performing crossover mutation. Crossover mutation includes combining multiple current instructions in a set of current instructions. In such a scenario, applying a crossover mutation includes selecting a subset of the set of current instructions, and performing the crossover mutation of the subset of the set of current instructions to obtain a set of revised instructions that include the revised instruction. Specifically, the evolutionary algorithm may include selecting a subset of current instructions to be mutated. A roulette wheel selection process may be used to select the subset. Cross-over mutation may be performed whereby two parents with distinct scores are crossed over using an LLM agent (e.g., the same or a separate LLM as used for the evaluation). The distinction that is used to select the two parents may be represented by cosine distance between corresponding vector embeddings of the instructions. Based on the crossover mutation, using the performance of the candidate revised instruction in the evaluation set, a test result is calculated. The test result is a score. The parents may be replaced with the newly generated mutations based on scores. Thus, the set of current instructions are updated. A detail flow performing evolutionary algorithm is described in reference to FIG. 4 and FIG. 5 below.

In Block 306, a first prompt that includes the current instruction with a first set of training examples selected by the example selector is tested by applying an LLM to obtain a first test result. An evaluation IO pair including an evaluation input and an evaluation output is selected. The first set of training examples is selected using the example selector. A first prompt is created with the current instruction, the first set of training examples, and the evaluation input. The first prompt is transmitted to the LLM to obtain a first LLM output. The LLM processes the first prompt to generate the first LLM output. The evaluation output is compared with the first LLM output to obtain the first test result. The comparison may be performed by encoding the evaluation output and the first LLM output to convert both output into vector space. A separate encoding model may be used that encodes the meaning of the respective output. A vector distance may be performed to determine how close the output is with respect to each other. By performing the encoding and calculating the vector distance, a string comparison is transformed to a numeric value indicating how close in meaning the respective output is to each other.

In Block 308, a second prompt including the revised instruction with a second set of training examples selected by the example selector is tested by applying the LLM to obtain a second test result. The second set of training examples is selected using the example selector. The second prompt is generated with the revised instruction, the second set of training examples, and an evaluation input to obtain a second LLM output. In some cases, the evaluation IO pair for the first prompt is the same as the evaluation IO pair for the second prompt. In other cases, a different evaluation IO pair is used. The evaluation output is compared with the second LLM output to obtain the second test result. Block 308 may be performed in a same or similar way to Block 306. The result is a second comparison of the respective outputs.

Further, the first set of training examples to test the current instruction and the second set of training examples to the test the revised instruction may be the same set of training examples. By using the same set of training examples, the comparison of the test results shows the differences between the instructions.

When multiple revised instructions are created, the set of revised instructions is tested to obtain a set of test results that include the second test result. Comparisons may then be performed using the set of test results.

In Block 310, the first test result is compared to a second test result to obtain a comparison result. In one or more embodiments, comparing the first test result to the second test result is a numeric comparison. The comparison determines whether the first LLM output generated using the current instruction or the second LLM output generated using the revised instruction is closer to the evaluation output and the degree of the difference. If the second LLM output is closer to the evaluation output, then in Block 312, the revised instruction is set as the current instruction.

In Block 314, a determination is made whether to continue the first phase. Specifically, the determination is made whether the comparison result satisfies a first phase stop condition. The phase stop condition may be the number of iterations of the first phase or the difference threshold being satisfied. The difference threshold may be that improvements to the instructions by further changes are minimal. If the determination is made to continue with the first phase, the next iteration of the first phase is started in Block 316.

If the determination is made not to continue with the first phase, the first phase is exited based on the comparison result satisfying the first phase stop condition. The flow proceeds to the second phase. In the second phase, the example selector is updated. The second phase may include multiple iterations.

In Block 320, a third set of training examples is selected by the example selector. An evaluation IO pair that includes an evaluation input and an evaluation output may be selected. Random selection of the evaluation IO pair may be performed. In one or more embodiments, the processing of Blocks 320 and 322 may be performed multiple times to perform several tests and generate multiple test results.

In one or more embodiments, the examples and the evaluation input of the evaluation IO pair are converted into vector space. For example, a vector encoding algorithm may be independently applied to each of the examples and to the evaluation input. The example selector may cluster evaluation examples in an example store using a clustering parameter to generate multiple clusters. For example, the clustering parameter may specify the degree of similarity between examples in the cluster or the number of clusters. For example, K-means clustering or other clustering algorithm may be used.

The example selector then selects, using a selection parameter and using the evaluation input, a training example from each of at least a subset of clusters to obtain the third set of training examples. The selection parameters may be a number of training examples in the third set of training parameters.

Selecting the training example may include selecting one or more examples from each cluster. First, a subset of clusters may be selected. In one or more embodiments, a parameter defines the number of the subset of clusters from which to select an example. In such embodiments, the nearest clusters to the example are selected. If, for example, the number is three, then the three nearest clusters are used. Further, another parameter may specify the number of examples to select from each cluster. For example, a single example may be selected from each of multiple clusters. In other embodiments, multiple examples are selected from each of the multiple clusters. The closest training example in a respective cluster is identified and selected as the training example for the respective cluster. In one or more embodiments, the nearest example(s) to the evaluation input are selected from each of the clusters. By selecting from multiple clusters, a diverse set of examples are selected. By selecting the nearest example(s) from the nearest cluster(s), a similarity exists between the evaluation input and the nearest cluster. Distance, such as used by nearest, may be vector distance. For a cluster, the vector distance may be to the centroid of the cluster or to the closest example in the cluster to the evaluation input.

In some embodiments, the example selector uses multiple example selection strategies. For example, the example selector may use a random selection strategy to select a number of examples. As another example, the example selector may use a k nearest neighbor selection strategy. With each selection strategy, the example selector selects a set of examples for the particular strategy. The number of examples selected may be defined by a weight assigned to each strategy. For example, if three example selection strategies are used, and the weights are 50% for a first strategy, 25% for the second strategy, and 25% for the third strategy, then half of the examples are selected using the first strategy, a fourth of the examples are selected using the second strategy, and a fourth of the examples are selected using the third strategy. If the total number of examples are twelve, then six examples are selected from the first strategy, and three examples are selected from each of the remaining two strategies. The weights are learned through training in Blocks 320-324.

The training examples are ordered using an ordering algorithm. In one or more embodiments, an ordering parameter is used as input to the ordering algorithm. For example, the ordering algorithm may be entropy based. Other ordering algorithms may be used.

In Block 322, using the current instruction, the third set of training examples is tested to obtain a third test result. Testing the third set of training examples may be performed similar to testing described in Blocks 306 and 308. However, in the second phase, the instruction is fixed. Specifically, a prompt is generated that includes the third set of training examples ordered according to the example selector, and the evaluation input, and the instruction. The prompt is transmitted to the LLM, which analyzes the prompt and generates an LLM output. The evaluation output is compared with the LLM output to generate the third test result. The comparison may be performed as discussed above.

In Block 324, after executing the first phase, the example selector is modified based on the third test result. Modifying the example selector may include modifying one or more of the parameters of the example selector. For example, the clustering parameter, the selection parameter, or the ordering parameter may be modified. As another example, the weights of multiple example selection strategies may be tuned.

In Block 326, a determination is made whether to continue with the second phase. Over the course of several iterations, the various parameters may be modified and tuned. The modification may be performed by adjusting small changes in the parameters and then determining whether the next test result is better than the prior test result. Further modification may be performed based on the differences between the test results. If a determination is made to continue the second phase, the next iteration of the second phase is started in Block 328. If the next iteration is started, the flow proceeds to Block 320.

If the determination is made not to proceed with the next iteration, the flow proceeds to Block 330. In Block 330, a determination is made whether to continue training. Continuing training may transfer the processing to the first phase. Specifically, the flow may proceed to Block 304. In the first phase, the update example selector is used to further update the instruction. By switching between the first phase and the second phase, the improvements in the instruction may improve the example selector. Improvements in the example selector may then be applied to improve the instruction. The processing may continue to perform until an exit criterion is satisfied. For example, the exit criteria may be that the difference between the test results is less than a threshold after performing both iterations. Namely, the overall LLM prompt creator is not further improved through training.

If a determination is made not to continue training, the flow may proceed to Block 332. In Block 332, the current instruction and the example selector are deployed to the production environment.

FIG. 4 shows a flowchart for gradient descent mutation (400) in an evolutionary algorithm framework, in accordance with one or more embodiments.

Gradient descent is an optimization algorithm that may be used in machine learning. Gradient descent aims to minimize a given function by iteratively adjusting the model parameters in the opposite direction of the gradient. The aim of the gradient descent mutation may be to cause the LLM to mutate an instruction based on a modification previously recommended by the LLM. In one embodiment, the gradient descent mutation function is performed when selected by the EA engine from the mutation function catalog.

At Block 402, a current instruction is selected from a set of current-generation instructions and a gradient descent mutation is performed. Blocks 404-412 present details of performing the gradient descent mutation. At Block 404, the current instruction, and at least one evaluation IO pair of the evaluation dataset are sent to the LLM with an instruction to generate a modification recommendation for the instruction. In some embodiments, all evaluation IO pairs are sent to the LLM with an instruction to generate a modification recommendation for the instruction. However, less than all evaluation IO pairs may be sent without departing from the scope of the claims.

When sent, the evaluation input of the evaluation IO pair corresponds to an input previously incorrectly processed by the LLM. The evaluation output of the evaluation IO pair includes the expected, or correct, response. In one embodiment, the instruction includes specific directions to generate a modification recommendation such that when the instruction is modified according to the generated modification recommendation, and subsequently presented to the LLM along with the evaluation input as a parameter, the LLM processes the evaluation input based on the modified instruction to generate a response that matches the evaluation output corresponding to the evaluation IO pair.

At Block 406, the modification recommendation is received by the EA engine from the LLM. Responsive to receiving the modification recommendation, the EA engine instructs the LLM to modify the current instruction according to the modification recommendation to generate a next-generation instruction such that processing the evaluation input based on the next-generation instruction causes the LLM to generate a response matching the evaluation output corresponding to the evaluation IO pair. In one embodiment, the LLM modifies the current instruction in accordance with the modification recommendation and returns the next-generation instruction.

Subsequently, the effectiveness of the next-generation instruction is assessed by evaluating the next-generation instruction. Accordingly, at Block 408, the evaluation input corresponding to the evaluation IO pair is processed by the LLM based on the next-generation instruction to generate a response. In one embodiment, the next-generation instruction, along with the evaluation input of the evaluation IO pair as a parameter, are presented to the LLM. The LLM processes the next-evaluation input in accordance with the next-generation instruction to generate a response. At Block 410, a fitness score is determined for the next-generation instruction based on a fitness function of the response generated by the LLM in Block 408 and the evaluation output corresponding to the evaluation IO pair. In one or more embodiments, the evaluation inputs corresponding to the evaluation IO pairs of the evaluation dataset are processed by the LLM with the next-generation instruction to evaluate the performance of the next-generation instruction. In one embodiment, the fitness function is selected by the EA engine from the fitness function catalog. In one embodiment, the fitness function is selected by the EA engine based on the goal of the instruction and the available data. For example, if the instruction is an instruction to check whether an input sentence is toxic, a toxicity score function is selected. In another example, if the expected response is a “True/False” type answer, an accuracy scoring function may be selected. At Block 412, the next-generation instruction is added to a next generation of instructions, responsive to the fitness score of the next-generation instruction being higher than an instruction fitness threshold. In one or more embodiments, the instruction fitness threshold may be a configuration variable of the gradient descent mutation function, a configuration variable of the EA engine, or variations thereof.

FIG. 5 shows a flowchart for determining distinct parent prompts for crossover mutation in an evolutionary algorithm framework, in accordance with one or more embodiments.

In the context of evolutionary algorithms, a crossover is a fundamental genetic operator that generates a “genetic” diversity and explores the solution space of candidate solutions. A crossover mutation combines information from two parent candidate solutions to create an offspring solution. In the context of the current specification, the crossover mutation function combines two parent prompts to create a new prompt. Examples of crossover mutations in evolutionary algorithms include one point crossover, two-point and k-point crossovers, uniform crossovers, and the like. Crossover mutation functions generate optimal new candidate solutions when two parent candidate solutions are selected for the mutation that are as distinct as possible in the solution space. In one embodiment, the candidate solutions result in orthogonal outcomes in the solution space, for example, if a first parent candidate solution generates a first set of outcomes in the solution domain, and a second parent candidate solution generates a second set of outcomes in the solution domain, then the first set of outcomes is mutually exclusive with the second set of outcomes.

In the context of prompt optimization in an EA framework, if a first parent prompt generates a first set of responses corresponding to the evaluation IO pairs of the evaluation dataset, a second parent prompt is selected that generates a second set of responses corresponding to the evaluation IO pairs. A goal is that the first and second subsets of responses represent mutually exclusive outcomes. In other words, the first and second parent prompts do not generate the same response for the same evaluation IO pair. However, in certain cases, the two parent prompts may generate common responses, correct or incorrect, for one or more of the same evaluation IO pairs. That is, both parents may generate a common correct or a common incorrect response for the same evaluation IO pair. In these cases, a measure of distinctness or dissimilarity between the two parent prompts is obtained. The measure of distinctness is inversely proportional to the number of common responses generated by the two parent prompts.

Accordingly, the two parent prompts are selected to undergo crossover mutation based on the respective performance of the parents against the evaluation dataset. In one embodiment, bit vectors are used to represent the performance of the parent prompts against the evaluation dataset to quantify the distinctness or dissimilarity between the two parent prompts. A bit vector is a data structure that compactly stores individual bits, i.e., zeroes (“0's”) and ones (“1's”). A Hamming distance is calculated for the bit vectors of the two parent prompts. In the context of bit vectors representing prompt performance against the evaluation dataset, the Hamming distance quantifies the dissimilarity between the two bit vectors by measuring how many bits are to be changed to transform one vector into the other. Thus, the Hamming distance models the measure of distinctness of the two parent prompts. Accordingly, in one embodiment, a Hamming distance is calculated to determine which pair of parent prompts may be presented as parameters to the crossover mutation function.

At Block 501, the EA engine selects a crossover mutation function from the mutation function catalog and performs a crossover mutation on the current generation of prompts to obtain a next generation of prompts. At Block 502, the prompts of the current generation of prompts are evaluated against the evaluation dataset to obtain corresponding bit vector representations of the performance of the prompts. In one embodiment, the evaluation inputs corresponding to the evaluation IO pairs of the evaluation dataset are presented as parameters along with a prompt to the LLM. The LLM processes the evaluation IO pairs based on the prompt to obtain a set of corresponding evaluation outputs. In an alternative embodiment, the evaluation output sets generated and stored from a previous evaluation step corresponding to the prompt, may be retrieved, for example, from the data repository. The evaluation outputs of the set of corresponding evaluation outputs are compared to evaluation outputs corresponding to the evaluation IO pairs to generate a bit vector corresponding to the prompt. The bit vector represents the performance of the prompt against the evaluation dataset. In one embodiment, if an evaluation output matches the corresponding evaluation output, a ‘1’ is added to the bit vector. If the evaluation output does not match the corresponding evaluation output, a ‘0’ is added to the bit vector. At Block 504, a first parent prompt is selected from the current generation of prompts. As described hereinabove, the Hamming distance quantifies the dissimilarity between the two vectors. That is, the greater the Hamming distance, the more distinct, or dissimilar, are the parent prompts. Therefore, the best second parent prompt is determined to be the prompt which has the greatest Hamming distance with respect to the first parent prompt.

Accordingly, at Block 506, a second parent prompt with the greatest Hamming distance with respect to the first parent prompt is selected from the current generation of prompts. In one embodiment, Hamming distances between the prompts of the current generation of prompts and the first parent prompt are calculated. The prompt that has the greatest Hamming distance with respect to the first parent prompt is selected as the second parent prompt. At Block 508, the first and second parent prompt are selected as a parameter pair to the crossover mutation function. In one or more embodiments, multiple parent prompt pairs are evaluated and selected from the current generation of prompts to undergo crossover mutation. The method 500 ends at Block 508.

While the various blocks of the flowcharts are presented and described sequentially, at least some of the blocks may be executed in different orders, may be combined or omitted, and at least some of the blocks may be executed in parallel. Furthermore, the blocks may be performed actively or passively.

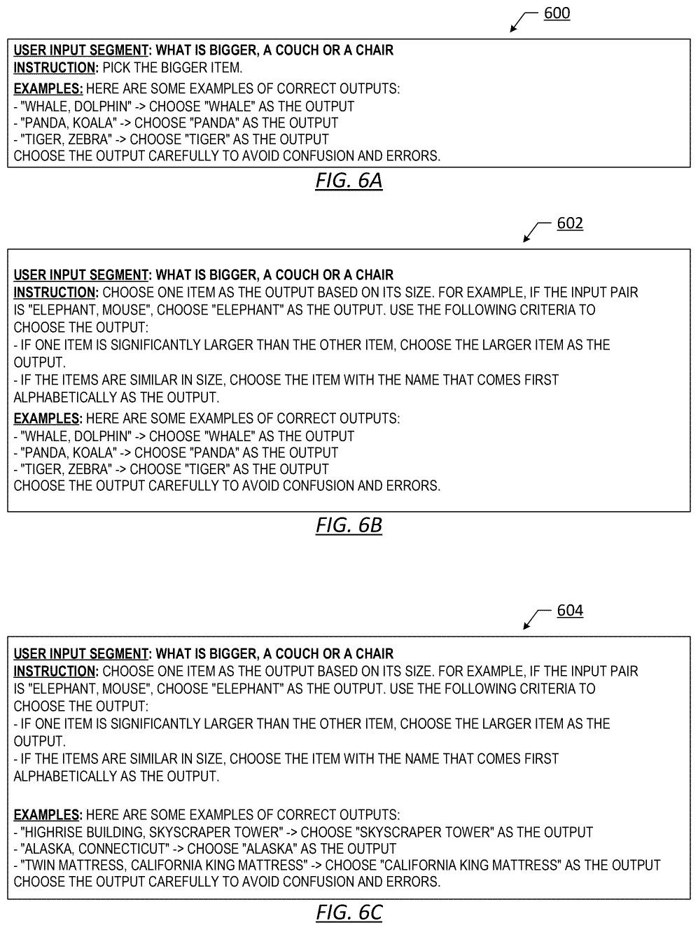

The following example is for explanatory purposes only and not intended to limit the scope of the invention. FIG. 6A, FIG. 6B, and FIG. 6C show an example in accordance with one or more embodiments. For the purposes of the example, the user prompt segment for the evaluation IO pair is the same to update the instruction and the example selector. However, during training, many IO pairs are used. Further, the method flows through several iterations to revise the instruction and several iterations to revise the example selector. The process repeats after the example selector is revised to further revise the instruction, etc.

Turning to FIG. 6A, an instruction “Pick the bigger item” is used along with several examples as shown in Block 600. “Pick the bigger item” may be ambiguous. Thus, through several iterations as shown in Block 602 of FIG. 6B, the instruction is changed to, “Choose one item as the output based on its size. For example, if the input pair is “elephant, mouse”, choose “elephant” as the output. Use the following criteria to choose the output: —If one item is significantly larger than the other item, choose the larger item as the output. —If the items are similar in size, choose the item with the name that comes first alphabetically as the output” along with the examples from the same example selector in FIG. 6A.

Once the instruction satisfies the first phase stop condition, the example selector is updated. As shown, each of the examples relate to animals, but the user input segment relates to furniture. Thus, in the second phase, through several iterations, the example selector is updated. The update to the example selector modifies the example selector based on the user input segment. In Block 604 of FIG. 6C, the example selector is updated to have more examples that are closer to furniture.

The process may repeat with the revised example selector to further update the instruction. Thus, through several iterations, the overall prompt is improved.

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 7A, the computing system (700) may include one or more computer processors (702), non-persistent storage (704), persistent storage (706), a communication interface (708) (e.g., Bluetooth interface, infrared interface, network interface, optical interface, etc.), and numerous other elements and functionalities that implement the features and elements of the disclosure. The computer processor(s) (702) may be an integrated circuit for processing instructions. The computer processor(s) may be one or more cores or micro-cores of a processor. The computer processor(s) (702) includes one or more processors. The one or more processors may include a central processing unit (CPU), a graphics processing unit (GPU), a tensor processing unit (TPU), combinations thereof, etc.

The input devices (710) may include a touchscreen, keyboard, mouse, microphone, touchpad, electronic pen, or any other type of input device. The input devices (710) may receive inputs from a user that are responsive to data and messages presented by the output devices (712). The inputs may include text input, audio input, video input, etc., which may be processed and transmitted by the computing system (700) in accordance with the disclosure. The communication interface (708) may include an integrated circuit for connecting the computing system (700) to a network (not shown) (e.g., a local area network (LAN), a wide area network (WAN) such as the Internet, mobile network, or any other type of network) and/or to another device, such as another computing device.

Further, the output devices (712) may include a display device, a printer, external storage, or any other output device. One or more of the output devices may be the same or different from the input device(s). The input and output device(s) may be locally or remotely connected to the computer processor(s) (702). Many different types of computing systems exist, and the aforementioned input and output device(s) may take other forms. The output devices (712) may display data and messages that are transmitted and received by the computing system (700). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system (700) in FIG. 7A may be connected to or be a part of a network. For example, as shown in FIG. 7B, the network (720) may include multiple nodes (e.g., node X (722), node Y (724)). Each node may correspond to a computing system, such as the computing system shown in FIG. 7A, or a group of nodes combined may correspond to the computing system shown in FIG. 7A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (700) may be located at a remote location and connected to the other elements over a network.

The nodes (e.g., node X (722), node Y (724)) in the network (720) may be configured to provide services for a client device (726), including receiving requests and transmitting responses to the client device (726). For example, the nodes may be part of a cloud computing system. The client device (726) may be a computing system, such as the computing system shown in FIG. 7A. Further, the client device (726) may include and/or perform all or a portion of one or more embodiments.

The computing system of FIG. 7A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an or may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
obtaining a current instruction and an example selector; and
for at least two iterations:
in a first phase, iteratively:
applying an evolutionary algorithm to the current instruction to generate a revised instruction,
testing, by applying a large language model (LLM), a first prompt comprising the current instruction with a first set of training examples selected by the example selector to obtain a first test result,
testing, by applying the LLM, a second prompt comprising the revised instruction with a second set of training examples selected by the example selector to obtain a second test result,
comparing the first test result to a second test result to obtain a comparison result,
setting the revised instruction as the current instruction, and
exiting the first phase when the comparison result satisfies a first phase stop condition, and
in a second phase:
selecting, by the example selector, a third set of training examples,
testing, using the current instruction, the third set of training examples to obtain a third test result, and
modifying, after executing the first phase, the example selector based on the third test result.

2. The method of claim 1, wherein applying the evolutionary algorithm comprises mutating the current instruction to generate the revised instruction.

3. The method of claim 1, wherein the current instruction is in a set of current instructions, and wherein applying the evolutionary algorithm comprises:
selecting a subset of the set of current instructions, and
performing a crossover mutation of the subset of the set of current instructions to obtain a set of revised instructions comprising the revised instruction,
wherein the set of revised instructions is tested to obtain a set of test results comprising the second test result,
wherein the comparison of the first test result with the second test result is performed using the set of test results.

4. The method of claim 1, wherein testing the first prompt with the current instruction comprises:
selecting an evaluation input output pair comprising an evaluation input and an evaluation output;
selecting the first set of training examples using the example selector;
transmitting, to the LLM, the first prompt with the current instruction, the first set of training examples, and the evaluation input to obtain a first LLM output; and
comparing the evaluation output with the first LLM output to obtain the first test result.

5. The method of claim 4, wherein testing the second prompt with the revised instruction comprises:
selecting the second set of training examples using the example selector;
transmitting, to the LLM, the second prompt with the revised instruction, the second set of training examples, and the evaluation input to obtain a second LLM output; and
comparing the evaluation output with the second LLM output to obtain the second test result.

6. The method of claim 5, wherein the first set of training examples and the second set of training examples are selected by the example selector using the evaluation input.

7. The method of claim 1, wherein the first set of training examples and the second set of training examples are a same set of training examples.

8. The method of claim 1, further comprising:
prior to the at least two iterations, randomly selecting an initial set of examples, each example in the initial set of examples comprising an input and a corresponding output,
sending a request to the LLM requesting that the LLM define an instruction that produces the corresponding output from the input for each example in the initial set of examples;
receiving the instruction from the LLM; and
using the instruction as the current instruction.

9. The method of claim 1, further comprising:
selecting an evaluation input output pair comprising an evaluation input and an evaluation output; and
clustering, by the example selector using a clustering parameter, a plurality of training examples in an example store to generate a plurality of clusters,
wherein, the example selector selects, using a selection parameter and using the evaluation input, a training example from each of at least a subset of clusters to obtain the third set of training examples, and
wherein modifying the example selector comprises modifying at least one of a plurality of parameters of the example selector based on the third test result, the plurality of parameters comprising the clustering parameter and the selection parameter.

10. The method of claim 9, wherein the clustering parameter is a number of clusters and wherein the selection parameter is a number of training examples in the third set of training parameters.

11. The method of claim 9, further comprising:
wherein selecting an example selects a single example from each of the at least the subset of clusters.

12. The method of claim 9, wherein selecting the training examples, comprises:
identifying a closest training example in a respective cluster of the at least the subset of clusters; and
selecting the closest training example as the training example for the respective cluster.

13. The method of claim 9, further comprising:
transmitting, to the LLM, a third prompt with the current instruction, the third set of training examples, and the evaluation input to obtain an LLM output; and
comparing the evaluation output with the LLM output to obtain the third test result.

14. The method of claim 9, further comprising:
ordering, by the example selector using an ordering parameter, the third set of examples according to an entropy-based method,
wherein the plurality of parameters further comprises the ordering parameter.

15. The method of claim 1, further comprising:
over a plurality of iterations of the second phase:
applying, by the example selector, a plurality of example selection strategies,
weighting the plurality of example selection strategies according to a set of weights to generate the third set of examples, and
tuning the set of weights according to the third test result.

16. The method of claim 15, wherein the plurality of example selection strategies comprises a set of parameters, and wherein the method further comprises:
modifying the set of parameters over the plurality of iterations of the second phase.

17. The method of claim 1, wherein the first phase is performed over a plurality of iterations before transitioning to the second phase.

18. A computing system comprising:
memory storing a plurality of instructions; and
a computer processor for executing the plurality of instructions to cause the computer system to perform operations comprising:
obtaining a current instruction and an example selector, and
for at least two iterations:
in a first phase, iteratively:
applying an evolutionary algorithm to the current instruction to generate a revised instruction,
testing, by applying a large language model (LLM), a first prompt comprising the current instruction with a first set of training examples selected by the example selector to obtain a first test result,
testing, by applying the LLM, a second prompt comprising the revised instruction with a second set of training examples selected by the example selector to obtain a second test result,
comparing the first test result to a second test result to obtain a comparison result,
setting the revised instruction as the current instruction, and
exiting the first phase when the comparison result satisfies a first phase stop condition, and
in a second phase:
selecting, by the example selector, a third set of training examples,
testing, using the current instruction, the third set of training examples to obtain a third test result, and
modifying, after executing the first phase, the example selector based on the third test result.

19. A method comprising:
obtaining a current instruction and an example selector;
for at least two iterations:
in a first phase, iteratively:
applying an evolutionary algorithm to the current instruction to generate a revised instruction,
testing, by applying a large language model (LLM), a first prompt comprising the current instruction with a first set of training examples selected by the example selector to obtain a first test result,
testing, by applying the LLM, a second prompt comprising the revised instruction with a second set of training examples selected by the example selector to obtain a second test result,
comparing the first test result to a second test result to obtain a comparison result,
setting the revised instruction as the current instruction, and
exiting the first phase when the comparison result satisfies a first phase stop condition, and
in a second phase:
selecting, by the example selector, a third set of training examples,
testing, using the current instruction, the third set of training examples to obtain a third test result, and
modifying, after executing the first phase, the example selector based on the third test result; and
deploying the current instruction and the example selector to a production environment.

20. The method of claim 19, further comprising:
receiving a user prompt segment from a user device,
selecting, by the example selector, a set of examples according to the user prompt segment,
generating an LLM prompt with the user prompt segment, the set of examples, and the current instruction,
transmitting the LLM prompt to the LLM,
receiving, responsive to the LLM prompt, a LLM result,
generating a user result from the LLM result, and
transmitting the user result to the user device responsive to the user prompt segment.
